(19) United States
(12) Patent Application Publication
(10) Pub. No.: US 2023/0085874 A1
(43) Pub. Date: Mar. 23, 2023

(54) ASSOCIATION OF PHASE TRACKING REFERENCE SIGNAL PORTS AND DEMODULATION REFERENCE SIGNAL PORTS FOR MULTI-BEAM UPLINK REPETITIONS

(71) Applicant: QUALCOMM Incorporated, San Diego, CA (US)

(72) Inventors: Mostafa KHOSHNEVISAN, San Diego, CA (US); Fang YUAN, Beijing (CN); Xiaoxia ZHANG, San Diego, CA (US); Tao LUO, San Diego, CA (US)

(21) Appl. No.: 17/904,574

(22) PCT Filed: Feb. 24, 2020
(86) PCT No.: PCT/CN2020/076336

§ 371 Date: Aug. 18, 2022

(51) Int. Cl. H04L 5/00; H04W 72/12

(52) U.S. Cl. CPC H04L 5/0051; H04W 72/1289

(57) ABSTRACT

Various aspects of the present disclosure generally relate to wireless communication. In some aspects, a user equipment may receive downlink control information (DCI) that schedules a first set of repetitions of an uplink communication according to a first set of transmission parameters, and a second set of repetitions of the uplink communication according to a second set of transmission parameters; determine one or more first phase tracking reference signal (PTRS) port and demodulation reference signal (DMRS) port associations for the first set of repetitions, and one or more second PTRS port and DMRS port associations for the second set of epetitions; and transmit PTRSs in the first set of repetitions and the second set of repetitions based at least in part on the one or more first PTRS port and DMRS port associations and the one or more second PTRS port and DMRS port associations. Numerous other aspects are provided.

### FIELD OF THE DISCLOSURE

Aspects of the present disclosure generally relate to wireless communication and to techniques and apparatuses for association of phase tracking reference signal ports and demodulation reference signal ports for multi-beam uplink repetitions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a user equipment (UE), may include receiving downlink control information (DCI) that schedules a first set of repetitions of an uplink communication according to a first set of transmission parameters, and a second set of repetitions of the uplink communication according to a second set of transmission parameters; determining one or more first phase tracking reference signal (PTRS) port and demodulation reference signal (DMRS) port associations for the first set of repetitions, and one or more second PTRS port and DMRS port associations for the second set of repetitions; and transmitting PTRSs in the first set of repetitions and the second set of repetitions based at least in part on the one or more first PTRS port and DMRS port associations and the one or more second PTRS port and DMRS port associations.

In some aspects, a method of wireless communication, performed by a base station (B S), may include determining that a first set of repetitions of an uplink communication are to be transmitted by a UE according to a first set of transmission parameters, and a second set of repetitions of the uplink communication are to be transmitted by the UE according to a second set of transmission parameters; and transmitting DCI that schedules the first set of repetitions according to the first set of transmission parameters, and the second set of repetitions according to the second set of transmission parameters, to enable the UE to determine one or more first PTRS port and DMRS port associations for the first set of repetitions, and one or more second PTRS port and DMRS port associations for the second set of repetitions.

In some aspects, a UE for wireless communication may include a memory and one or more processors operatively coupled to the memory. The memory and the one or more processors may be configured to receive DCI that schedules a first set of repetitions of an uplink communication according to a first set of transmission parameters, and a second set of repetitions of the uplink communication according to a second set of transmission parameters; determine one or more first PTRS port and DMRS port associations for the first set of repetitions, and one or more second PTRS port and DMRS port associations for the second set of repetitions; and transmit PTRSs in the first set of repetitions and the second set of repetitions based at least in part on the one or more first PTRS port and DMRS port associations and the one or more second PTRS port and DMRS port associations.

In some aspects, a BS for wireless communication may include a memory and one or more processors operatively coupled to the memory. The memory and the one or more processors may be configured to determine that a first set of repetitions of an uplink communication are to be transmitted by a UE according to a first set of transmission parameters, and a second set of repetitions of the uplink communication are to be transmitted by the UE according to a second set of transmission parameters; and transmit DCI that schedules the first set of repetitions according to the first set of transmission parameters, and the second set of repetitions according to the second set of transmission parameters, to enable the UE to determine one or more first PTRS port and DMRS port associations for the first set of repetitions, and one or more second PTRS port and DMRS port associations for the second set of repetitions.

In some aspects, a non-transitory computer-readable medium may store one or more instructions for wireless communication. The one or more instructions, when executed by one or more processors of a UE, may cause the one or more processors to receive DCI that schedules a first set of repetitions of an uplink communication according to a first set of transmission parameters, and a second set of repetitions of the uplink communication according to a second set of transmission parameters; determine one or more first PTRS port and DMRS port associations for the first set of repetitions, and one or more second PTRS port and DMRS port associations for the second set of repetitions; and transmit PTRSs in the first set of repetitions and the second set of repetitions based at least in part on the one or more first PTRS port and DMRS port associations and the one or more second PTRS port and DMRS port associations.

In some aspects, a non-transitory computer-readable medium may store one or more instructions for wireless communication. The one or more instructions, when executed by one or more processors of a BS, may cause the one or more processors to determine that a first set of repetitions of an uplink communication are to be transmitted by a UE according to a first set of transmission parameters, and a second set of repetitions of the uplink communication are to be transmitted by the UE according to a second set of transmission parameters; and transmit DCI that schedules the first set of repetitions according to the first set of transmission parameters, and the second set of repetitions according to the second set of transmission parameters, to enable the UE to determine one or more first PTRS port and DMRS port associations for the first set of repetitions, and one or more second PTRS port and DMRS port associations for the second set of repetitions.

In some aspects, an apparatus for wireless communication may include means for receiving DCI that schedules a first set of repetitions of an uplink communication according to a first set of transmission parameters, and a second set of repetitions of the uplink communication according to a second set of transmission parameters; means for determining one or more first PTRS port and DMRS port associations for the first set of repetitions, and one or more second PTRS port and DMRS port associations for the second set of repetitions; and means for transmitting PTRSs in the first set of repetitions and the second set of repetitions based at least in part on the one or more first PTRS port and DMRS port associations and the one or more second PTRS port and DMRS port associations.

In some aspects, an apparatus for wireless communication may include means for determining that a first set of repetitions of an uplink communication are to be transmitted by a UE according to a first set of transmission parameters, and a second set of repetitions of the uplink communication are to be transmitted by the UE according to a second set of transmission parameters; and means for transmitting DCI that schedules the first set of repetitions according to the first set of transmission parameters, and the second set of repetitions according to the second set of transmission parameters, to enable the UE to determine one or more first PTRS port and DMRS port associations for the first set of repetitions, and one or more second PTRS port and DMRS port associations for the second set of repetitions.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station (BS) in communication with a user equipment (UE) in a wireless communication network, in accordance with various aspects of the present disclosure.

FIGS. 3 and 4 are diagrams illustrating examples of association of phase tracking reference signal ports and demodulation reference signal ports for multi-beam uplink repetitions, in accordance with various aspects of the present disclosure.

FIG. 5 is a diagram illustrating an example process performed, for example, by a UE, in accordance with various aspects of the present disclosure.

FIG. 6 is a diagram illustrating an example process performed, for example, by a BS, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

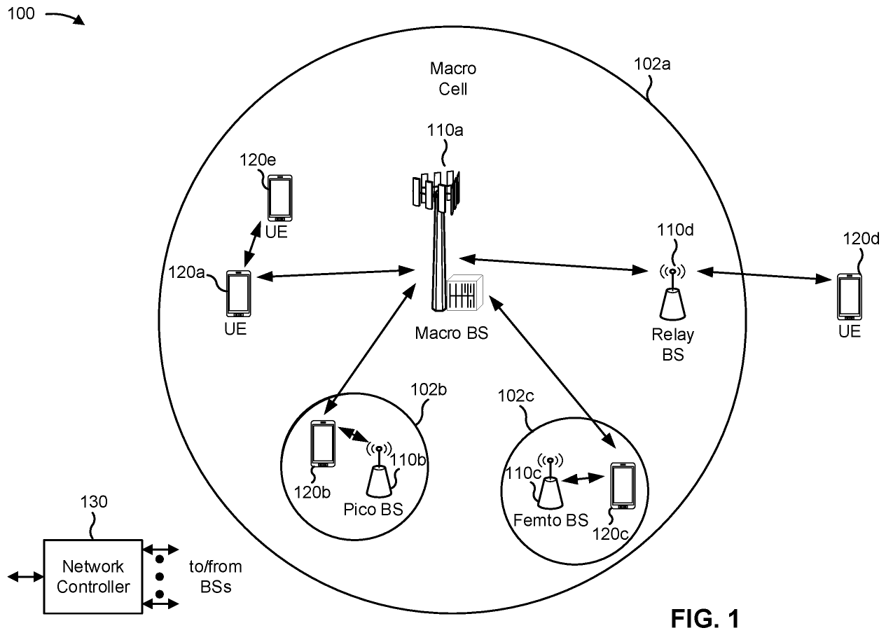

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of base stations (BSs) 110 (shown as BS 110a, BS 110b, BS 110c, and BS 110d) and other network entities. ABS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

ABS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband interne of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

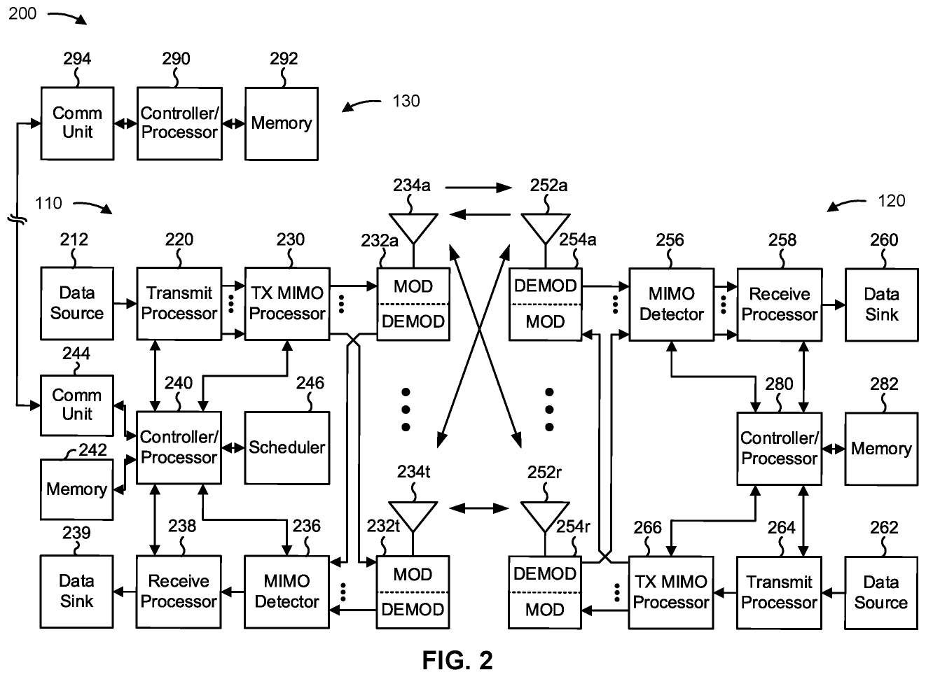

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T>1 and R>1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

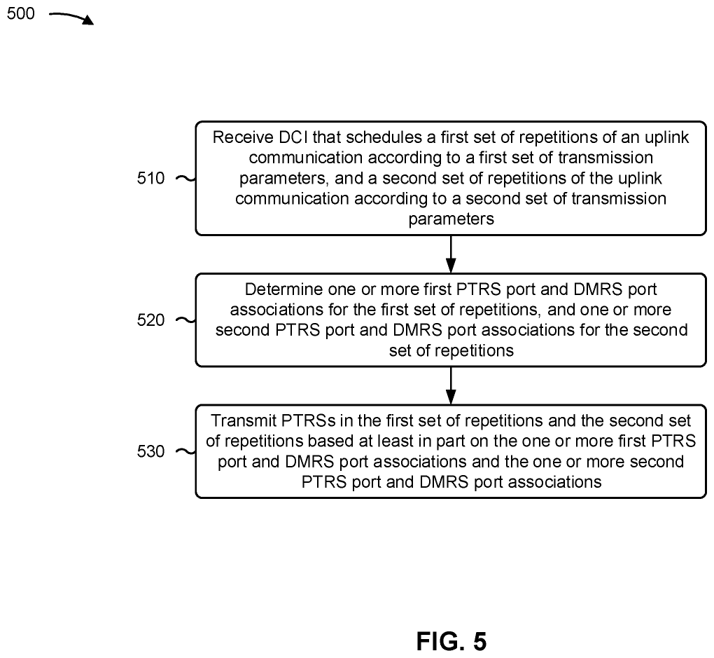

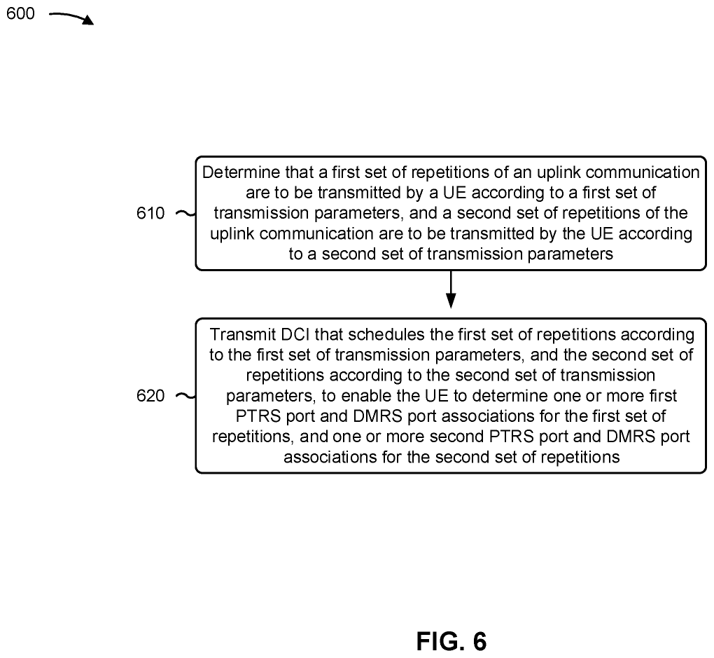

Controller/processor 240 of base station 110, controller/processor 280 of UE 120, and/or any other component(s) of FIG. 2 may perform one or more techniques related to association of phase tracking reference signal (PTRS) ports and demodulation reference signal (DMRS) ports for multi-beam uplink repetitions, as described in more detail elsewhere herein. For example, controller/processor 240 of base station 110, controller/processor 280 of UE 120, and/or any other component(s) of FIG. 2 may perform or direct operations of, for example, process 500 of FIG. 5, process 600 of FIG. 6, and/or other processes as described herein. Memories 242 and 282 may store data and program codes for base station 110 and UE 120, respectively. In some aspects, memory 242 and/or memory 282 may comprise a non-transitory computer-readable medium storing one or more instructions for wireless communication. For example, the one or more instructions, when executed (e.g., directly, or after compiling, converting, interpreting, and/or the like) by one or more processors of the base station 110 and/or the UE 120, may perform or direct operations of, for example, process 500 of FIG. 5, process 600 of FIG. 6, and/or other processes as described herein. In some aspects, executing instructions may include running the instructions, converting the instructions, compiling the instructions, interpreting the instructions, and/or the like. A scheduler 246 may schedule UEs for data transmission on the downlink and/or uplink.

In some aspects, UE 120 may include means for receiving downlink control information (DCI) that schedules a first set of repetitions of an uplink communication according to a first set of transmission parameters, and a second set of repetitions of the uplink communication according to a second set of transmission parameters, means for determining one or more first PTRS port and DMRS port associations for the first set of repetitions, and one or more second PTRS port and DMRS port associations for the second set of repetitions, means for transmitting PTRSs in the first set of repetitions and the second set of repetitions based at least in part on the one or more first PTRS port and DMRS port associations and the one or more second PTRS port and DMRS port associations, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for determining that a first set of repetitions of an uplink communication are to be transmitted by a UE according to a first set of transmission parameters, and a second set of repetitions of the uplink communication are to be transmitted by the UE according to a second set of transmission parameters, means for transmitting DCI that schedules the first set of repetitions according to the first set of transmission parameters, and the second set of repetitions according to the second set of transmission parameters, to enable the UE to determine one or more first PTRS port and DMRS port associations for the first set of repetitions, and one or more second PTRS port and DMRS port associations for the second set of repetitions, and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

As indicated above, FIG. 2 is provided as an example. Other examples may differ from what is described with regard to FIG. 2.

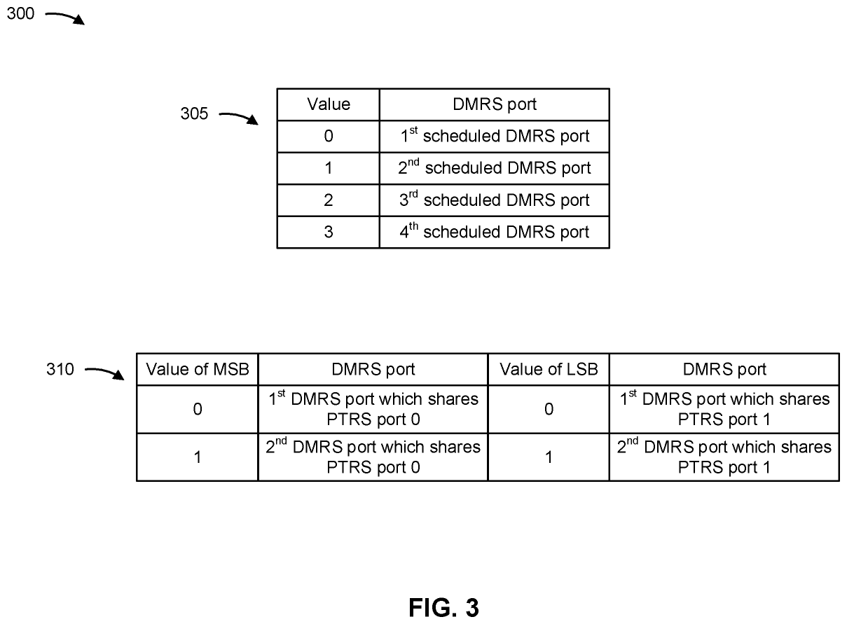

FIG. 3 is a diagram illustrating an example 300 of association of PTRS ports and DMRS ports for multi-beam uplink repetitions, in accordance with various aspects of the present disclosure.

A PTRS may be used to correct phase noise (e.g., oscillator phase noise), especially for millimeter wave communications. A PTRS may be transmitted on a layer that is mapped to a particular DMRS port, such as a DMRS port associated with a strongest signal. In some cases, a UE may identify multiple PTRS ports and/or multiple DMRS ports that may be used. Accordingly, DCI that schedules an uplink communication may indicate one or more PTRS port and DMRS port associations that each identify a particular DMRS port that is to be used to transmit a particular PTRS.

In non-codebook-based uplink, the UE may identify one or more PTRS ports based at least in part on a sounding reference signal (SRS) resource indicator (SRI). For example, an SRI may identify one or more multiple SRS resources, and each SRS resource may be configured with a particular PTRS port. In codebook-based uplink, the UE may identify one or more PTRS ports based at least in part on a transmit precoding matrix indicator (TPMI) and an indicated quantity of layers, as described below. Moreover, the UE may be configured to use a particular maximum quantity of PTRS ports, which may be one or two. The UE may be configured to use one PTRS port when the UE is fully coherent. The UE may be configured to use at most two PTRS ports when the UE is non-coherent or partially coherent (e.g., the UE may be configured to use two PTRS ports when a transmission uses a cyclic prefix orthogonal frequency-division multiplexing (CP-OFDM) waveform).

If the UE identifies a single PTRS port (e.g., PTRS port 0), the DCI may indicate an index value of mapping 305 to identify a DMRS port associated with the PTRS port (where the first scheduled DMRS port may refer to a DMRS port mapped to a first layer that is to be transmitted, and so forth). If the UE identifies multiple PTRS ports (e.g., PTRS port 0 and PTRS port 1), the DCI may indicate two index values of mapping 310 to identify respective DMRS ports associated with the multiple PTRS ports.

As shown in mapping 310, a first index value (i.e., a most-significant bit (MSB)) may identify a DMRS port of a set of DMRS ports that share a first PTRS port (e.g., PTRS port 0), and a second index value (i.e., a least-significant bit (LSB)) may identify a DMRS port of a set of DMRS ports that share a second PTRS port (e.g., PTRS port 1). In non-codebook-based uplink, DMRS ports and SRS resources have a one-to-one mapping, and therefore, DMRS ports that map to SRS resources that are configured with the same PTRS port may share the PTRS port. In codebook-based uplink, a first set of antennas (e.g., antennas 0 and 2) of a precoding matrix (identified by a TPMI and an indicated quantity of layers) may be associated with a first PTRS port (e.g., PTRS port 0) and a second set of antennas (e.g., antennas 1 and 3) of the precoding matrix may be associated with a second PTRS port (e.g., PTRS port 1). Accordingly, DMRS ports, mapped to layers of the precoding matrix that are to be transmitted using antennas of a particular set of antennas, may share the PTRS port associated with the particular set of antennas.

In some wireless telecommunication systems, a UE may transmit multiple repetitions of an uplink communication that are received by different TRPs, antenna panels, antennas, and/or the like, of a BS. This may improve a reliability and a performance of the uplink communication. In some cases, the UE may determine (e.g., based at least in part on DCI) the same PTRS port and DMRS port association for the multiple repetitions. However, performance of a PTRS is improved when the PTRS is transmitted on a DMRS port associated with the strongest signal, which may not be the same DMRS port for the different receivers of the multiple repetitions.

Some techniques and apparatuses described herein enable a UE to determine respective PTRS port and DMRS port associations for multiple sets of repetitions of an uplink communication that are to be transmitted using different transmission parameters (e.g., using different beams). In this way, a PTRS for a set of repetitions may be transmitted using a DMRS port indicated for the set of repetitions that is associated with the strongest signal, thereby improving performance of the PTRS and performance of the set of repetitions.

As indicated above, FIG. 3 is provided as an example. Other examples may differ from what is described with respect to FIG. 3.

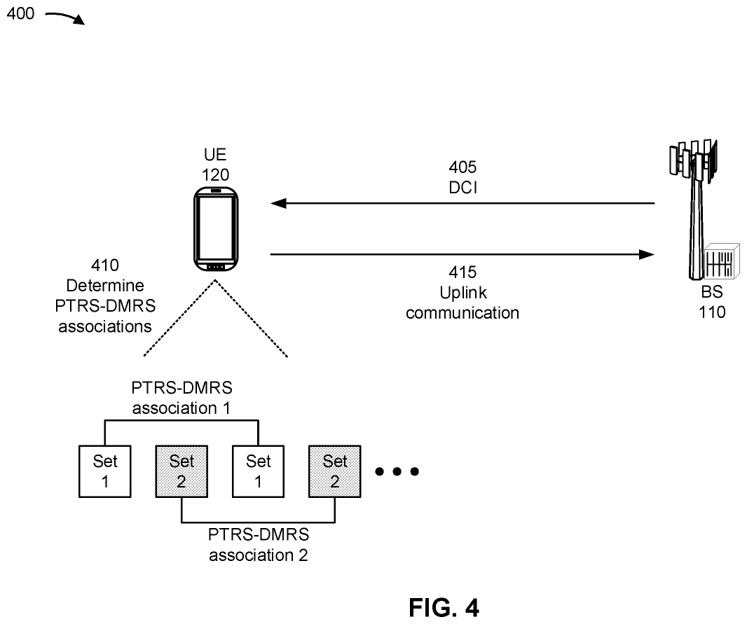

FIG. 4 is a diagram illustrating an example 400 of association of PTRS ports and DMRS ports for multi-beam uplink repetitions, in accordance with various aspects of the present disclosure. As shown in FIG. 4, a UE 120 and a BS 110 may communicate in connection with an uplink communication in a physical uplink shared channel (PUSCH).

As shown by reference number 405, the BS 110 may transmit, and the UE 120 may receive, DCI. The DCI may schedule multiple repetitions (i.e., PUSCH transmission occasions) of an uplink communication of the UE 120. For example, the DCI may schedule a first set of repetitions of the uplink communication (Set 1) according to a first set of transmission parameters, and a second set of repetitions of the uplink communication (Set 2) according to a second set of transmission parameters. That is, the DCI may provide uplink grants for the first and second sets of repetitions, and may indicate respective sets of transmission parameters for the first and second sets of repetitions. In some aspects, the repetitions may have multiple layers.

In some aspects, the first set of transmission parameters and the second set of transmission parameters may be different. For example, the first set of transmission parameters may indicate one or more of a first uplink beam (e.g., a spatial parameter, such as a quasi-co-location (QCL) parameter, a transmission configuration indicator (TCI) state, a spatial domain filter, and/or the like), a first set of uplink power control parameters, or a first TPMI, and the second set of transmission parameters may indicate one or more of a second uplink beam (e.g., a spatial parameter, such as a QCL parameter, a TCI state, a spatial domain filter, and/or the like), a second set of uplink power control parameters, or a second TPMI.

In some aspects, the DCI may indicate (e.g., in an antenna ports field of the DCI) the same, or respective, sets of DMRS ports for the first and second set of repetitions. In some aspects, the DCI may indicate the same, or respective, SRIs for the first and second sets of repetitions (e.g., in non-codebook-based uplink). In some aspects, the DCI may indicate the same, or respective, TPMIs and quantities of layers (e.g., precoding matrices) for the first and second sets of repetitions (e.g., in codebook-based uplink). As described in connection with FIG. 3, the UE 120 may identify one or more PTRS ports for the first set of repetitions and the second set of repetitions based at least in part on the SRIs and/or TPMIs and quantities of layers indicated by the DCI. In some aspects, the UE 120 may identify different quantities of PTRS ports for the first and second sets of repetitions.

In some aspects, the DCI may indicate one or more PTRS port and DMRS port association indications, which identify one or more PTRS port and DMRS port associations. A PTRS port and DMRS port association indication may be referred to herein as a PTRS-DMRS association indication, and a PTRS port and DMRS port association may be referred to herein as a PTRS-DMRS association. The DCI may identify one or more PTRS-DMRS associations in a PTRS-DMRS association field. Thus, a value of the PTRS-DMRS association field may be a PTRS-DMRS association indication.

In some aspects, the PTRS-DMRS association field may be allocated two bits of the DCI, and the DCI may indicate a single PTRS-DMRS association indication. A single PTRS-DMRS association indication may indicate a single index value (e.g., of the mapping 305), when a single PTRS port is identified by the UE 120, or two index values (e.g., of the mapping 310) when multiple PTRS ports are identified by the UE 120. In some aspects, the PTRS-DMRS association field may be allocated four bits of the DCI, and the DCI may indicate respective PTRS-DMRS association indications for the sets of repetitions. Each of the respective PTRS-DMRS association indications may be a single PTRS-DMRS association indication, as described above. In some aspects, the PTRS-DMRS association field may be allocated two bits of the DCI that are repurposed for indicating respective PTRS-DMRS associations for the first and second sets of repetitions when the repetitions have at most two layers (e.g., exactly two layers).

As shown by reference number 410, the UE 120 may determine PTRS-DMRS associations for the first set of repetitions and the second set of repetitions. For example, the UE 120 may determine one or more first PTRS-DMRS associations (PTRS-DMRS association 1) for the first set of repetitions, and one or more second PTRS-DMRS associations (PTRS-DMRS association 2) for the second set of repetitions.

In some aspects, the UE 120 may determine the one or more first PTRS-DMRS associations and the one or more second PTRS-DMRS associations based at least in part on a single PTRS-DMRS association indication of the DCI (e.g., using two bits of the PTRS-DMRS association field of the DCI), as described above. For example, a single PTRS-DMRS association indication may be an index value (e.g., when the UE 120 identifies a single PTRS port) that identifies a PTRS-DMRS association (e.g., according to mapping 305) or two index values (e.g., when the UE 120 identifies multiple PTRS ports) that identify two PTRS-DMRS associations (e.g., according to mapping 310).

Accordingly, the UE 120 may determine the one or more first PTRS-DMRS associations for the first set of repetitions based at least in part on the single PTRS-DMRS association indication, and the one or more second PTRS-DMRS associations for the second set of repetitions based at least in part on the single PTRS-DMRS association indication. The single PTRS-DMRS association indication (e.g., a single index value of mapping 305 or two index values of mapping 310) may identify different PTRS-DMRS associations for the first and second sets of repetitions because the first and second sets of repetitions may use different quantities of PTRS ports, different sets of DMRS ports may be indicated for the first and second sets of repetitions, and/or the like.

Thus, for example, the UE 120 may determine one or two PTRS-DMRS associations for the first set of repetitions based at least in part on the single PTRS-DMRS association indication, and one or two PTRS-DMRS associations for the second set of repetitions based at least in part on the single PTRS-DMRS association indication. As an example, the single PTRS-DMRS association indication may have a value of 01, the UE 120 may identify one PTRS port for the first set of repetitions, and the UE 120 may identify two PTRS ports for the second set of repetitions. In this example, the UE 120 may determine one PTRS-DMRS association for the first set of repetitions according to a DMRS port association of 01 (e.g., a value of 1) in mapping 305, and two PTRS-DMRS associations for the second set of repetitions according to DMRS port associations of 01 (e.g., an MSB value of 0 and an LSB value of 1) in mapping 310.

In some aspects, the UE 120 may use the single PTRS-DMRS association indication to determine the one or more first PTRS-DMRS associations for the first set of repetitions, and the one or more second PTRS-DMRS associations for the second set of repetitions, when the DCI indicates one or more different transmission parameters for the first set of repetitions and the second set of repetitions. For example, the DCI may indicate a first TPMI or a first quantity of layers (e.g., a first precoding matrix) for the first set of repetitions, and a second TPMI or a second quantity of layers (e.g., a second precoding matrix) for the second set of repetitions. As another example, the DCI may indicate a first set of DMRS ports for the first set of repetitions, and a second set of DMRS ports for the second set of repetitions. As a further example, the DCI may indicate a first set of SRS resources (e.g., according to a first SRI) for the first set of repetitions, and second set of SRS resources (e.g., according to a second SRI) for the second set of repetitions.

In some aspects, the UE 120 may determine the one or more first PTRS-DMRS associations and the one or more second PTRS-DMRS associations based at least in part on respective PTRS-DMRS association indications of the DCI (e.g., using four bits of the PTRS-DMRS association field of the DCI), as described above. In this example, the first two bits may indicate a single PTRS-DMRS association indication (e.g., a single index value of mapping 305 or two index values of mapping 310) that identifies one or more PTRS-DMRS associations for the first set of repetitions, and the second two bits may indicate a single PTRS-DMRS association indication (e.g., a single index value of mapping 305 or two index values of mapping 310) that identifies one or more PTRS-DMRS associations for the second set of repetitions. For example, the single PTRS-DMRS association indication of the first two bits may identify one or two PTRS-DMRS associations for the first set of repetitions based at least in part on whether the UE 120 identifies one or two PTRS ports for the first set of repetitions, and so forth.

In some aspects, the UE 120 may employ an interpretation, different from that described above, of the two bits of the PTRS-DMRS association field of the DCI in order to determine the one or more first PTRS-DMRS associations and the one or more second PTRS-DMRS associations, as described above. In this example, a first bit of the PTRS-DMRS association field of the DCI may be for indicating the one or more first PTRS-DMRS associations, and a second bit of the PTRS-DMRS association field of the DCI may be for indicating the one or more second PTRS-DMRS associations. In some aspects, the UE 120 may employ this interpretation when the repetitions have at most two layers. For example, the UE 120 may employ this interpretation when one or more sets of DMRS ports indicated for the first and second sets of repetitions include at most two DMRS ports per set of DMRS ports.

In some aspects, a value of the first bit may be based at least in part on a first quantity of PTRS ports that the UE 120 has identified for the first set of repetitions, and a value of the second bit may be based at least in part on a second quantity of PTRS ports that the UE 120 has identified for the second set of repetitions. As described in connection with FIG. 3, the UE 120 may identify a quantity of PTRS ports that are to be transmitted by a set of repetitions based at least in part on SRS resources indicated by the DCI for the set of repetitions (in the case of non-codebook-based uplink) or a TPMI and a quantity of layers indicated by the DCI for the set of repetitions (in the case of codebook-based uplink). In some aspects, the UE 120 may determine the same, or different, quantity of PTRS ports for the first and second sets of repetitions based at least in part on whether the DCI indicates the same, or different, SRS resources or TPMI and quantity of layers for the first and second sets of repetitions.

In some aspects, if the UE 120 is non-coherent or partially coherent, the quantity of PTRS ports may be one or two PTRS ports. In some aspects, if the UE 120 is fully coherent, the quantity of PTRS ports may be one PTRS port.

In some aspects, if the UE 120 identifies one PTRS port for the first set of repetitions, then a value of the first bit may indicate whether the one PTRS port is associated with a first DMRS port or a second DMRS port of a set of DMRS ports (which may include two DMRS ports, as described above) indicated for the first set of repetitions. Similarly, if the UE 120 identifies one PTRS port for the second set of repetitions, then a value of the second bit may indicate whether the one PTRS port is associated with a first DMRS port or a second DMRS port of a set of DMRS ports (which may include two DMRS ports, as described above) indicated for the second set of repetitions.

In some aspects, if the UE 120 identifies two PTRS ports for the first set of repetitions, then the UE 120 may determine a mapping of the two PTRS ports to a set of DMRS ports (which may include two DMRS ports, as described above) indicated for the first set of repetitions. This mapping may be determined (e.g., uniquely determined) by implementation of the UE 120. Similarly, if the UE 120 identifies two PTRS ports for the second set of repetitions, then the UE 120 may determine (e.g., by implementation of the UE 120) a mapping of the two PTRS ports to a set of DMRS ports (which may include two DMRS ports, as described above) indicated for the second set of repetitions.

As shown by reference number 415, the UE 120 may transmit, and the BS 110 may receive, the first set of repetitions of the uplink communication and the second set of repetitions of the uplink communication. For example, the UE 120 may transmit the first set of repetitions based at least in part on the one or more first PTRS-DMRS associations determined by the UE 120, and the second set of repetitions based at least in part on the one or more second PTRS-DMRS associations determined by the UE 120. That is, the UE 120 may transmit one or more first PTRSs (identified by the UE 120 for the first set of repetitions, as described above) in the first set of repetitions using one or more DMRS ports according to the one or more first PTRS-DMRS associations, and transmit one or more second PTRSs (identified by the UE 120 for the second set of repetitions, as described above) in the second set of repetitions using one or more DMRS ports according to the one or more second PTRS-DMRS associations. In this way, performance of the PTRSs and the uplink communication may be improved.

In some aspects, the UE 120 may transmit the first set of repetitions to a first TRP, antenna panel, antenna, and/or the like, of the BS 110, and the second set of repetitions to a second TRP, antenna panel, antenna, and/or the like, of the BS 110. In some aspects, the first TRP, antenna panel, antenna, and/or the like, and the second TRP, antenna panel, antenna, and/or the like, may be associated with different BSs.

As indicated above, FIG. 4 is provided as an example. Other examples may differ from what is described with respect to FIG. 4.

FIG. 5 is a diagram illustrating an example process 500 performed, for example, by a UE, in accordance with various aspects of the present disclosure. Example process 500 is an example where the UE (e.g., UE 120, and/or the like) performs operations related to association of PTRS ports and DMRS ports for multi-beam uplink repetitions.

As shown in FIG. 5, in some aspects, process 500 may include receiving DCI that schedules a first set of repetitions of an uplink communication according to a first set of transmission parameters, and a second set of repetitions of the uplink communication according to a second set of transmission parameters (block 510). For example, the UE (e.g., using antenna 252, DEMOD 254, MIMO detector 256, receive processor 258, controller/processor 280, and/or the like) may receive DCI that schedules a first set of repetitions of an uplink communication according to a first set of transmission parameters, and a second set of repetitions of the uplink communication according to a second set of transmission parameters, as described above.

As further shown in FIG. 5, in some aspects, process 500 may include determining one or more first PTRS port and DMRS port associations for the first set of repetitions, and one or more second PTRS port and DMRS port associations for the second set of repetitions (block 520). For example, the UE (e.g., using controller/processor 280, and/or the like) may determine one or more first PTRS port and DMRS port associations for the first set of repetitions, and one or more second PTRS port and DMRS port associations for the second set of repetitions, as described above.

As further shown in FIG. 5, in some aspects, process 500 may include transmitting PTRSs in the first set of repetitions and the second set of repetitions based at least in part on the one or more first PTRS port and DMRS port associations and the one or more second PTRS port and DMRS port associations (block 530). For example, the UE (e.g., using controller/processor 280, transmit processor 264, TX MIMO processor 266, MOD 254, antenna 252, and/or the like) may transmit PTRSs in the first set of repetitions and the second set of repetitions based at least in part on the one or more first PTRS port and DMRS port associations and the one or more second PTRS port and DMRS port associations, as described above.

Process 500 may include additional aspects, such as any single aspect or any combination of aspects described below and/or in connection with one or more other processes described elsewhere herein.

In a first aspect, the first set of repetitions and the second set of repetitions are scheduled with more than one layer.

In a second aspect, alone or in combination with the first aspect, the first set of transmission parameters indicate one or more of a first uplink beam, a first spatial domain filter, a first set of uplink power control parameters, or a first TPMI, and the second set of transmission parameters indicate one or more of a second uplink beam, a second spatial domain filter, a second set of uplink power control parameters, or a second TPMI.

In a third aspect, alone or in combination with one or more of the first and second aspects, the one or more first PTRS port and DMRS port associations and the one or more second PTRS port and DMRS port associations are determined based at least in part on a single PTRS port and DMRS port association indication of the DCI. In a fourth aspect, alone or in combination with one or more of the first through third aspects, the one or more first PTRS port and DMRS port associations and the one or more second PTRS port and DMRS port associations are determined based at least in part on the single PTRS port and DMRS port association indication when at least one of: the DCI indicates a first TPMI or a first quantity of layers for the first set of repetitions, and a second TPMI or a second quantity of layers for the second set of repetitions, the DCI indicates a first set of DMRS ports for the first set of repetitions, and a second set of DMRS ports for the second set of repetitions, or the DCI indicates first SRS resources for the first set of repetitions, and second SRS resources for the second set of repetitions.

In a fifth aspect, alone or in combination with one or more of the first through fourth aspects, the one or more first PTRS port and DMRS port associations and the one or more second PTRS port and DMRS port associations are determined based at least in part on respective PTRS port and DMRS port association indications of the DCI.

In a sixth aspect, alone or in combination with one or more of the first through fifth aspects, a first bit of a field of the DCI is for indicating the one or more first PTRS port and DMRS port associations, and a second bit of the field of the DCI is for indicating the one or more second PTRS port and DMRS port associations. In a seventh aspect, alone or in combination with one or more of the first through sixth aspects, the first set of repetitions and the second set of repetitions are scheduled with at most two layers.

In an eighth aspect, alone or in combination with one or more of the first through seventh aspects, a value of the first bit is based at least in part on a first quantity of PTRS ports that are to be used for the first set of repetitions, and a value of the second bit is based at least in part on a second quantity of PTRS ports that are to be used for the second set of repetitions. In a ninth aspect, alone or in combination with one or more of the first through eighth aspects, the value of the first bit, when the first quantity of PTRS ports is one, or the value of the second bit, when the second quantity of PTRS ports is one, indicates whether a single PTRS port is associated with a first DMRS port or a second DMRS port. In a tenth aspect, alone or in combination with one or more of the first through ninth aspects, the one or more first PTRS port and DMRS port associations are determined without reference to the value of the first bit when the first quantity of PTRS ports is two, and the one or more second PTRS port and DMRS port associations are determined without reference to the value of the second bit when the second quantity of PTRS ports is two.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a BS, in accordance with various aspects of the present disclosure. Example process 600 is an example where the BS (e.g., BS 110, and/or the like) performs operations related to association of PTRS ports and DMRS ports for multi-beam uplink repetitions.

As shown in FIG. 6, in some aspects, process 600 may include determining that a first set of repetitions of an uplink communication are to be transmitted by a UE according to a first set of transmission parameters, and a second set of repetitions of the uplink communication are to be transmitted by the UE according to a second set of transmission parameters (block 610). For example, the BS (e.g., using controller/processor 240, and/or the like) may determine that a first set of repetitions of an uplink communication are to be transmitted by a UE according to a first set of transmission parameters, and a second set of repetitions of the uplink communication are to be transmitted by the UE according to a second set of transmission parameters, as described above.

As further shown in FIG. 6, in some aspects, process 600 may include transmitting DCI that schedules the first set of repetitions according to the first set of transmission parameters, and the second set of repetitions according to the second set of transmission parameters, to enable the UE to determine one or more first PTRS port and DMRS port associations for the first set of repetitions, and one or more second PTRS port and DMRS port associations for the second set of repetitions (block 620). For example, the BS (e.g., using controller/processor 240, transmit processor 220, TX MIMO processor 230, MOD 232, antenna 234, and/or the like) may transmit DCI that schedules the first set of repetitions according to the first set of transmission parameters, and the second set of repetitions according to the second set of transmission parameters, to enable the UE to determine one or more first PTRS port and DMRS port associations for the first set of repetitions, and one or more second PTRS port and DMRS port associations for the second set of repetitions, as described above.

Process 600 may include additional aspects, such as any single aspect or any combination of aspects described below and/or in connection with one or more other processes described elsewhere herein.

In a first aspect, the first set of repetitions and the second set of repetitions are scheduled with more than one layer.

In a second aspect, alone or in combination with the first aspect, the first set of transmission parameters indicate one or more of a first uplink beam, a first spatial domain filter, a first set of uplink power control parameters, or a first TPMI, and the second set of transmission parameters indicate one or more of a second uplink beam, a second spatial domain filter, a second set of uplink power control parameters, or a second TPMI.

In a third aspect, alone or in combination with one or more of the first and second aspects, the one or more first PTRS port and DMRS port associations and the one or more second PTRS port and DMRS port associations are to be determined based at least in part on a single PTRS port and DMRS port association indication of the DCI. In a fourth aspect, alone or in combination with one or more of the first through third aspects, the one or more first PTRS port and DMRS port associations and the one or more second PTRS port and DMRS port associations are to be determined based at least in part on the single PTRS port and DMRS port association indication when at least one of: the DCI indicates a first TPMI or a first quantity of layers for the first set of repetitions, and a second TPMI or a second quantity of layers for the second set of repetitions, the DCI indicates a first set of DMRS ports for the first set of repetitions, and a second set of DMRS ports for the second set of repetitions, or the DCI indicates first SRS resources for the first set of repetitions, and second SRS resources for the second set of repetitions.

In a fifth aspect, alone or in combination with one or more of the first through fourth aspects, the one or more first PTRS port and DMRS port associations and the one or more second PTRS port and DMRS port associations are to be determined based at least in part on respective PTRS port and DMRS port association indications of the DCI.

In a sixth aspect, alone or in combination with one or more of the first through fifth aspects, a first bit of a field of the DCI is for indicating the one or more first PTRS port and DMRS port associations, and a second bit of the field of the DCI is for indicating the one or more second PTRS port and DMRS port associations. In a seventh aspect, alone or in combination with one or more of the first through sixth aspects, the first set of repetitions and the second set of repetitions are scheduled with at most two layers.

In an eighth aspect, alone or in combination with one or more of the first through seventh aspects, a value of the first bit is based at least in part on a first quantity of PTRS ports that are to be used for the first set of repetitions, and a value of the second bit is based at least in part on a second quantity of PTRS ports that are to be used for the second set of repetitions. In a ninth aspect, alone or in combination with one or more of the first through eighth aspects, the value of the first bit, when the first quantity of PTRS ports is one, or the value of the second bit, when the second quantity of PTRS ports is one, indicates whether a single PTRS port is associated with a first DMRS port or a second DMRS port. In a tenth aspect, alone or in combination with one or more of the first through ninth aspects, the one or more first PTRS port and DMRS port associations are to be determined without reference to the value of the first bit when the first quantity of PTRS ports is two, and the one or more second PTRS port and DMRS port associations are to be determined without reference to the value of the second bit when the second quantity of PTRS ports is two.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method of wireless communication performed by a user equipment (UE), comprising:
receiving downlink control information (DCI) that schedules a first set of repetitions of an uplink communication according to a first set of transmission parameters, and a second set of repetitions of the uplink communication according to a second set of transmission parameters;
transmitting phase tracking reference signals (PTRs) in the first set of repetitions and the second set of repetitions based at least in part on one or more first PTRS port and demodulation reference signal (DMRS) port associations for the first set of repetitions and one or more second PTRS port and DMRS port associations for the second set of repetitions.

2. The method of claim 1, wherein the first set of repetitions and the second set of repetitions are scheduled with more than one layer.

3. The method of claim 1, wherein the first set of transmission parameters indicate one or more of a first uplink beam, a first spatial domain filter, a first set of uplink power control parameters, or a first transmit precoding matrix indicator (TPMI), and the second set of transmission parameters indicate one or more of a second uplink beam, a second spatial domain filter, a second set of uplink power control parameters, or a second TPMI.

4. The method of claim 1, wherein the one or more first PTRS port and DMRS port associations and the one or more second PTRS port and DMRS port associations are based at least in part on a single PTRS port and DMRS port association indication of the DCI.

5. The method of claim 4, wherein the one or more first PTRS port and DMRS port associations and the one or more second PTRS port and DMRS port associations are based at least in part on the single PTRS port and DMRS port association indication when at least one of:
the DCI indicates a first transmit precoding matrix indicator (TPMI) or a first quantity of layers for the first set of repetitions, and a second TPMI or a second quantity of layers for the second set of repetitions,
the DCI indicates a first set of DMRS ports for the first set of repetitions, and a second set of DMRS ports for the second set of repetitions, or
the DCI indicates first sounding reference signal (SRS) resources for the first set of repetitions, and second SRS resources for the second set of repetitions.

6. The method of claim 1, wherein the one or more first PTRS port and DMRS port associations and the one or more second PTRS port and DMRS port associations are based at least in part on respective PTRS port and DMRS port association indications of the DCI.

7. The method of claim 1, wherein a first bit of a field of the DCI is for indicating the one or more first PTRS port and DMRS port associations, and a second bit of the field of the DCI is for indicating the one or more second PTRS port and DMRS port associations.

8. The method of claim 7, wherein the first set of repetitions and the second set of repetitions are scheduled with at most two layers.

9. The method of claim 7, wherein a value of the first bit is based at least in part on a first quantity of PTRS ports that are to be used for the first set of repetitions, and a value of the second bit is based at least in part on a second quantity of PTRS ports that are to be used for the second set of repetitions.

10. The method of claim 9, wherein the value of the first bit, when the first quantity of PTRS ports is one, or the value of the second bit, when the second quantity of PTRS ports is one, indicates whether a single PTRS port is associated with a first DMRS port or a second DMRS port.

11. The method of claim 9, wherein the one or more first PTRS port and DMRS port associations are reference to the value of the first bit when the first quantity of PTRS ports is two, and the one or more second PTRS port and DMRS port associations are without reference to the value of the second bit when the second quantity of PTRS ports is two.

12. A method of wireless communication performed by a base station, comprising:
determining that a first set of repetitions of an uplink communication are to be transmitted by a user equipment (UE) according to a first set of transmission parameters, and a second set of repetitions of the uplink communication are to be transmitted by the UE according to a second set of transmission parameters; and
transmitting downlink control information (DCI) that schedules the first set of repetitions according to the first set of transmission parameters, and the second set of repetitions according to the second set of transmission parameters, to indicate one or more first phase tracking reference signal (PTRS) port and demodulation reference signal (DMRS) port associations for the first set of repetitions, and one or more second PTRS port and DMRS port associations for the second set of repetitions.

13. The method of claim 12, wherein the first set of repetitions and the second set of repetitions are scheduled with more than one layer.

14. The method of claim 12, wherein the first set of transmission parameters indicate one or more of a first uplink beam, a first spatial domain filter, a first set of uplink power control parameters, or a first transmit precoding matrix indicator (TPMI), and the second set of transmission parameters indicate one or more of a second uplink beam, a second spatial domain filter, a second set of uplink power control parameters, or a second TPMI.

15. The method of claim 12, wherein the one or more first PTRS port and DMRS port associations and the one or more second PTRS port and DMRS port associations are based at least in part on a single PTRS port and DMRS port association indication of the DCI.

16. The method of claim 15, wherein the one or more first PTRS port and DMRS port associations and the one or more second PTRS port and DMRS port associations are based at least in part on the single PTRS port and DMRS port association indication when at least one of:
the DCI indicates a first transmit precoding matrix indicator (TPMI) or a first quantity of layers for the first set of repetitions, and a second TPMI or a second quantity of layers for the second set of repetitions,
the DCI indicates a first set of DMRS ports for the first set of repetitions, and a second set of DMRS ports for the second set of repetitions, or
the DCI indicates first sounding reference signal (SRS) resources for the first set of repetitions, and second SRS resources for the second set of repetitions.

17. The method of claim 12, wherein the one or more first PTRS port and DMRS port associations and the one or more second PTRS port and DMRS port associations are based at least in part on respective PTRS port and DMRS port association indications of the DCI.

18. The method of claim 12, wherein a first bit of a field of the DCI is for indicating the one or more first PTRS port and DMRS port associations, and a second bit of the field of the DCI is for indicating the one or more second PTRS port and DMRS port associations.

19. The method of claim 18, wherein the first set of repetitions and the second set of repetitions are scheduled with at most two layers.

20. The method of claim 18, wherein a value of the first bit is based at least in part on a first quantity of PTRS ports that are to be used for the first set of repetitions, and a value of the second bit is based at least in part on a second quantity of PTRS ports that are to be used for the second set of repetitions.

21. The method of claim 20, wherein the value of the first bit, when the first quantity of PTRS ports is one, or the value of the second bit, when the second quantity of PTRS ports is one, indicates whether a single PTRS port is associated with a first DMRS port or a second DMRS port.

22. The method of claim 20, wherein the one or more first PTRS port and DMRS port associations are reference to the value of the first bit when the first quantity of PTRS ports is two, and the one or more second PTRS port and DMRS port associations are without reference to the value of the second bit when the second quantity of PTRS ports is two.

23-28. (canceled)

29. The method of claim 1, wherein a quantity of PTRSs that are transmitted in the first set of repetitions or the second set of repetitions is based at least in part on sounding reference signal (SRS) resources indicated by the DCI.

30. A user equipment (UE) for wireless communication, comprising:
a memory; and
one or more processors operatively coupled to the memory, the one or more processors configured to:
receive downlink control information (DCI) that schedules a first set of repetitions of an uplink communication according to a first set of transmission parameters, and a second set of repetitions of the uplink communication according to a second set of transmission parameters; and
transmit phase tracking reference signals (PTRSs) in the first set of repetitions and the second set of repetitions based at least in part on one or more first PTRS port and demodulation reference signal (DMRS) port associations for the first set of repetitions and one or more second PTRS port and DMRS port associations for the second set of repetitions.

31. The UE of claim 31, wherein the first set of transmission parameters indicate one or more of a first uplink beam, a first spatial domain filter, a first set of uplink power control parameters, or a first transmit precoding matrix indicator (TPMI), and the second set of transmission parameters indicate one or more of a second uplink beam, a second spatial domain filter, a second set of uplink power control parameters, or a second TPMI.

32. The UE of claim 31, wherein the one or more first PTRS port and DMRS port associations and the one or more second PTRS port and DMRS port associations are based at least in part on respective PTRS port and DMRS port association indications of the DCI.

33. The UE of claim 31, wherein a first bit of a field of the DCI is for indicating the one or more first PTRS port and DMRS port associations, and a second bit of the field of the DCI is for indicating the one or more second PTRS port and DMRS port associations.

34. The UE of claim 34, wherein the first set of repetitions and the second set of repetitions are scheduled with at most two layers.

35. The UE of claim 31, wherein a quantity of PTRSs that are transmitted in the first set of repetitions or the second set of repetitions is based at least in part on sounding reference signal (SRS) resources indicated by the DCI.

36. A base station for wireless communication, comprising:
a memory; and
one or more processors operatively coupled to the memory, the one or more processors configured to:
determine that a first set of repetitions of an uplink communication are to be transmitted by a user equipment (UE) according to a first set of transmission parameters, and a second set of repetitions of the uplink communication are to be transmitted by the UE according to a second set of transmission parameters; and
transmit downlink control information (DCI) that schedules the first set of repetitions according to the first set of transmission parameters, and the second set of repetitions according to the second set of transmission parameters, to indicate one or more first phase tracking reference signal (PTRS) port and demodulation reference signal (DMRS) port associations for the first set of repetitions, and one or more second PTRS port and DMRS port associations for the second set of repetitions.
